(19) United States
(12) Patent Application Publication
(10) Pub. No.: US 2002/0020945 A1
(43) Pub. Date: Feb. 21, 2002

(54) Forming three dimensional objects through bulk heating of layers with differential material properties

(76) Inventors: Uichung Cho, Austin, TX (US); David Charles Thompson, Dublin, CA (US)

Correspondence Address: UICHUNG CHO, 7105 Teya Court, Austin, TX, 78749, US

(21) Appl. No.: 09/932,618

(22) Filed: Aug. 17, 2001

Related U.S. Application Data
(60) Provisional application No. 60/226,398, filed on Aug. 18, 2000.

(51) Int. Cl. B29C 35/08; B29C 41/02

(52) U.S. Cl. 264/460; 264/113; 264/308

(57) ABSTRACT

The technical disclosures of this invention are comprised of (1) a process for manufacturing parts, (2) techniques used for material distribution in this process, and (3) techniques used for consolidation of material in this process. The manufacturing process is an embodiment of layered freeform fabrication of parts of arbitrary geometry based on the use of bulk consolidation operations as opposed to previous methods which selectively consolidate regions of a layer at a time. In order to select which areas are consolidated, variations of material properties are created before consolidation. Two techniques are presented for creating these variations: a technique using an additive to change material properties and a technique using multiple materials distributed in an arbitrary pattern to form a layer. When an additive is used, a single material is deposited to form a layer and additive is selectively applied with an inkjet-style print head. When multiple materials are used, the materials must be selectively applied to form a layer. This is accomplished with one of two techniques: an vibrating membrane whose forced vibrational modes distribute powder in the intended pattern or a series of flexible gated compartments that change shape as powder is being deposited.

### REFERENCES CITED

U.S. Patent Documents

U.S. Pat. No. 5,059,266 October 1991 Yamane et al. 156/64

U.S. Pat. No. 5,076,869 December 1991 Bourell, et al. 156/62.2

U.S. Pat. No. 5,136,515 August 1992 Helinski 364/468

U.S. Pat. No. 5,263,130 November 1993 Pomerantz et al. 395/118

U.S. Pat. No. 5,301,415 April 1994 Prinz et al. 29/458

U.S. Pat. No. 5,340,656 August 1994 Sachs et al. 428/546

U.S. Pat. No. 5,354,414 October 1994 Feygin 156/630

U.S. Pat. No. 5,387,380 February 1995 Cima et al. 264/69

U.S. Pat. No. 5,398,193 March 1995 deAngelis 364/468

U.S. Pat. No. 5,506,607 April 1996 Sanders, Jr. et al. 347/1

U.S. Pat. No. 5,555,481 September 1996 Rock et al. 419/30

U.S. Pat. No. 5,578,227 November 1996 Rabinovich, 219/121.63

U.S. Pat. No. 5,617,911 April 1997 Sterett et al. 164/457

U.S. Pat. No. 5,622,216 April 1997 Brown 164/71.1

U.S. Pat. No. 5,648,450 July 1997 Dickens, Jr. et al. 528/323

U.S. Pat. No. 5,718,951 February 1998 Sterett et al. 427/466

U.S. Pat. No. 5,730,925 March 1998 Mattes et al. 264/497

U.S. Pat. No. 5,787,965 August 1998 Sterett et al. 164/155.3

U.S. Pat. No. 5,817,206 October 1998 McAlea, et al. 156/272.8

U.S. Pat. No. 5,934,343 August 1999 Gaylo et al. 141/12

U.S. Pat. No. 5,943,235 August 1999 Earl et al. 364/468.04

U.S. Pat. No. 5,980,812 November 1999 Lawton 264/401

Other Publications

[1] Aubin, R. F. A World Wide Assessment of Rapid Prototyping Technologies. Proceedings of Solid Freeform Fabrication Symposium, 1994, pp.118-145.

[2] Beck, J. E. et al. Manufacturing Mechatronics using Thermal Spray Shape Deposition. Proceedings of Solid Freeform Fabrication Symposium, 1992, pp.272-279.

[3] Birley, A. W. et al. Plastics Materials ? Properties and Applications, Chapman and Hall, Inc., New York., 1988

[4] Das, S. et al. Direct Selective Laser Sintering and Containerless Hot Isostatic Pressing for High Performance Metal Components. Proceedings of Solid Freeform Fabrication Symposium, 1997, pp.81-90.

[5] Dornfield W. H. Direct Dynamic Testing of Scaled Stereolithographic Models. Sound and Vibration, 1995, pp. 12-17.

[6] Erhun, M. and Advani, S. G. Heat Transfer Effects during Solidification of Semicrystalline Polymers. ASME Journal of Engineering Materials and Technology, Vol. 115, January 1993, pp. 30-36.

[7] Fertis, D. G. Nonlinear Mechanics, CRC Press, Inc., 1993

[8] Fessler, J. R. et al. Functional Gradient Metallic Prototypes through Shape Deposition Manufacturing. Proceedings of Solid Freeform Fabrication Symposium, 1997, pp.521-528.

[9] Griffith, M. L. et al. Multiple-Material Processing by LENS. Proceedings of Solid Freeform Fabrication Symposium, 1997, pp.387-394.

[10] Halwel, D. and Klameckl, B. E., Characterization of Force Sensors Embedded in Surfaces for Manufacturing Process Monitoring. ASME Manufacturing Science and Engineering, Vol.64, 1991, pp.207-216.

[11] Jacobs, P. F. Rapid Prototyping and Manufacturing: Fundamentals of StereoLithography, Society of Manufacturing Engineers, McGraw-Hill Inc., 1992

[12] Jepson, L. et al. SLS processing of Functionally Gradient Materials. Proceedings of Solid Freeform Fabrication Symposium, 1997, pp.67-80.

[13] Kumar, A. and Zhang, H. Electrophotographic Powder Deposition for Freeform Fabrication. Proceedings of Solid Freeform Fabrication Symposium, 1999, pp.647-653.

[14] Kumar, A. Solid freeform fabrication using powder deposition, U.S., Pat. No. 6,066,285, May 23,

[15] Nelson, J. C., et al. Post-Processing of Selective Laser Sintered Polycarbonate Parts. Proceedings of Solid Freeform Fabrication Symposium, 1993, pp. 78-85.

[16] Nickel, A. et al. Residual Stresses in Layered Manufacturing. Proceedings of Solid Freeform Fabrication Symposium, 1999, pp.239-246.

[17] Prinz, M. R. Shape Deposition Manufacturing, Proceedings of Solid Freeform Fabrication Symposium, 1994, pp. 1-8.

[18] Rock, S. and Gilman, C. A New SFF Process for Functional Part Rapid Prototyping and Manufacturing: Freeform Powder Molding, Proceedings of Solid Freeform Fabrication Symposium, 1995, pp. 80-87.

[19] Rock, et. al. Method of producing solid parts using two distinct classes of materials, U.S. Pat. No. 5,555,481, Sep. 10, 1996

[20] Sachs, E. et al. Production of Injection Molding Tooling with Conformal Cooling Channels using the Three Dimensional Printing Process. Proceedings of Solid Freeform Fabrication Symposium, 1995, pp. 448-467.

[21] Safari, S. et al. Processing of Novel Piezoelectric Transducers Via SFF. Proceedings of Solid Freeform Fabrication Symposium, 1997, pp.403-410.

[22] Schmidt, L. D. Applications of Stereolithography in the Automotive Industry, Successful Applications of Rapid Prototyping Technologies Conference, SME, 1991, pp.23-24.

[23] Smith, S. H. et al. A Calibration Approach for Smart Structures Using Embedded Sensors. Experimental Techniques, March/April 1992, pp.25-31.

[24] Steinchen, W., Kramer, B., Kupfer, G. Photoelastic Investigation Using New STL-Resins. Proceedings of Solid Freeform Fabrication Symposium, 1995, pp.204-212.

[25] Sun, L. et al. Fabrication of In-situ SiC/C Thermocouples by SALD. Proceedings of Solid Freeform Fabrication Symposium, 1997, pp.481-488.

[26] Wall, M. B. et al. Making Sense of Prototyping Technologies for Product Design. ASME 3rd International Conference on Design Theory and Methodology, Vol. 31, 1991, pp.157-164.

[27] Wohlers, T., Wohlers Report 2000, 2000.

### CLASSIFICATION

This application is a continuation-in-part of application Ser. No. 60/226,398, filed August 18, 2000. This invention is in the field of solid freeform fabrication on the basis of the following physical phenomena:

1. A fixed temperature source of heat will have different rates of heat flow to different materials or mixtures of materials.

2. Different materials or mixtures of materials can have different melting points.

3. Materials with different heat diffusion coefficients, a, that are initially in thermal equilibrium will take different amounts of time to reach equilibrium when put into a new environment.

### BACKGROUND OF THE INVENTION

This invention relates generally to the field of Solid Freeform Fabrication (SFF) and powder based thermal forming processes to produce three-dimensional objects, especially with complex geometry. In the context of SFF processes, wherein objects are produced layer-by-layer, this invention particularly relates to an SFF process and apparatus for producing objects by depositing materials, where the deposited powder layer is uniformly heated and actively cooled to fabricate three dimensional objects with small geometrical distortion and desirable mechanical characteristics. For the last two decades, several novel manufacturing processes have been developed to fabricate geometrically complex parts with dramatically reduced time and cost. Such processes are called Rapid Prototyping and Manufacturing (RP&M) or SFF processes. Their defining characteristic is their ability to fabricate parts without frequent human intervention and part-geometry dependent jigs/tools [1,9,11,21]. Product designers can accelerate design processes by fabricating prototypes with SFF processes to visualize the product earlier in the design process, to enhance communications between customers and design teams, and to improve quality with tolerance or even functional testing [5,11,22]. In addition, SFF processes are beneficial for mass manufacturing, for example by cost and time effectively providing patterns for molding [1,11]. However, SFF processes have not been used to directly mass-manufacture parts. There are several reasons for this. Current RP&M processes can effectively fabricate geometrically complex parts but from a very limited selection of materials. The high price of most RP&M systems is another critical factor that prevents wider use and mass manufacturing by creating many parts in parallel. Finally, it is difficult to find existing SFF techniques that are suitable to rapidly fabricate large parts with geometric accuracy at a price competitive with conventional manufacturing. This invention does not have all of these limitations.

The governing physical phenomena of this invention are similar to Selective Laser Sintering (SLS) and Freeform Powder Molding (FPM) [6,4,12,13,18,19,20]. SLS, for example, is a powder-based process that creates a layer of a single powder and selectively sinters the powder using a laser. Only regions exposed to the laser are solidified and become part of the final product. The expensive laser system is the key element of SLS that makes the system price high. Also, when building large parts, non negligible thermal distortion is detectable due to the concentrated heating and uneven cooling caused by adding heat energy using the local heating of the laser.

Freeform Powder Molding (FPM) is another similar SFF process in which geometry of complex parts is constructed exploiting powder zones with different material properties [18,19]. Unlike this invention, FPM sinters powder only after all layers have been deposited. Parts fabricated with this process show significant geometric distortion [19]. Gravitational effects mainly cause the distortion, and larger parts result in more serious distortions. Also, FPM provides no specific means to deliver multiple powders, whereas this invention covers several embodiments.

3-D Printing is technique that uses an inkjet-style print head to selectively distribute a binder on top of a layer of powder (U.S. Pat. No. 5,387,380, [20]). After the binder is cured, the surrounding powder is removed. This leaves a part whose strength is dependent on the strength of the binder. Although additional post-processing can remove the binder and melt the powder particles together, this produces parts with low density and porous surfaces. Post-processing also reduces the dimensional accuracy. Recently, Kumar proposed a new powder delivery concept to fabricate parts similar to FPM [13,14]. The powder delivery concept delivers powder by attracting charged powder particles to a photoelectrically charged film. As the concept attracts and deposits multiple classes of powder in two dimensions instead of one dimension, one can expect fast part fabrication. However, this concept can only handle materials that can be electrically charged. While coating other materials with an electrical insulator is possible, it introduces problems such as reduced part density and chemical reactions between the coating and other elements of the system. Kumar's process also involves aligning layers of one material with layers of another material. This is a difficult task.

The objective of this patent is to provide a conceptually new SFF process that is superior to existing processes in terms of fabrication speed, system and processing costs and producable part size. In comparison to laser based SFF processes, not only the system cost but also the time to fabricate parts can be dramatically reduced, considering the time required to scan large areas using a laser. This process speed difference can be huge if large scale parts are fabricated. Geometric accuracy is another critical factor that determines performance of current SFF systems. Thermal gradients, which create stress and residual heat that causes part growth in a homogeneous powder, are key factors that cause geometric inaccuracy. Many current SFF processes needs improvement to fabricate geometrically accurate large parts.

This invention has been devised to for the following purposes: (1) Rapid prototyping of large parts; (2) Manufacturing (as opposed to prototyping) seamless large systems (e.g., airplane wings or automobile bodies). (3) Prototyping/Manufacturing parts cost-effectively; (4) Fabricating many copies of the same parts in a powder bed at once for mass production.

### BRIEF SUMMARY OF THE INVENTION

The method and apparatus for fabricating three dimensional objects by repetitively constructing thin layers of materials, each composed of continuous zones with different material properties, where the different material properties are achieved by depositing two classes of materials or “doping” selected zones of a layer with an additive. After deposition, each layer is uniformly heated and cooled to consolidate only selected zones. This same process consolidates selected zones with any underlying regions that have also been selected.

The preferred embodiment, but not the only embodiment, uses layers composed of powders and an additive that is a liquid which is vaporized during consolidation; in zones where the powder (1) has a melting point below the temperature to which the layer is heated and (2) no dopant has been added, the powder is melted and thus consolidated. If the powder (1) has a melting point above the temperature to which the layer is heated or (2) has been wetted by an additive, the powder is not melted. These zones are selectively deposited to form geometrical boundaries that represent the intersection of a three dimensional object with the shape of the layer. For the case when the zones are composed of two different powders, these powders must be selectively deposited. Several embodiments are proposed to deposit powders selectively in a layer: (1) A liquid is dropped to a specific area of a sheet to selectively hold powder; (2) An array of actuators attached to a membrane is used to generate modal shapes which direct the powder; and/or (3) An array of powder chambers with moving gates is employed. Once the powders are deposited, the layer is uniformly heated to fuse the part material and adhere it to the previous layer. The melted powder layer is actively cooled for minimal thermal distortion and residual stress of fabricated parts. For the case when the zones are formed by selectively wetting powders, liquid is selectively dropped onto a layer of a powder. As the layer is heated and cooled, only the dry areas are consolidated. The two cases can be combined so that both multiple materials and a dopant are employed. In this case, the phase change of the dopant prevents unwanted chemical reactions from occurring as the temperature of the material without the dopant is changed.

### BRIEF DESCRIPTION OF DRAWINGS

The invention can be better understood through the FIGS. 1-XX, which are schematic views of a preferred embodiment of the invention.

FIG. 1 is overall process to be created with two different initial sub-processes and an exemplary three-dimensional object created from the process;

FIG. 2 is the flow chart of a preferred embodiment of the invention, employing the method of differentiating local material properties by dispensing liquid at predefined areas of a layer.

FIG. 3 is the flow chart of a preferred embodiment of the invention, employing the method of differentiating local material properties by delivering different materials on a layer.

FIG. 4 is the schematic of a preferred embodiment of the sub-process to dispense fine liquid drops at predefined areas.

FIGS. 5A and 5B respectively describe the method to wet predefined areas of a powder layer using the liquid dispenser depicted in FIG. 4, with a single and multiple paths.

FIG. 6 depicts an embodiment where multiple materials are deposited, one at a time, using a linear array of piezoelectric actuators. The actuators vibrate the membrane on which the powder rests. Only nodes of the vibration allow the powder to be at rest. By changing the forcing function, we can position nodes wherever we need to get the desired powder distribution along the array. The array is moved along the surface and powder is deposited as the motion progresses.

FIGS. 7A and 7B respectively shows front and bottom view of the preferred embodiment to deliver different classes of powders at predefined areas.

FIG. 8 depicts two configurations of the multiple powder delivery system shown in FIGS. 7A and 7B to achieve two different sections of the powder layer.

### DETAILED DESCRIPTION OF THE INVENTION

Similar to existing rapid prototyping or solid freeform fabrication processes, a computer representation of a solid is “sliced” into layers by intersecting the layer's surface equation with the CAD model. Each layer is then represented by a parametric surface representing a cross-section of the model. A layer of materials (powders are the preferred embodiment) are then physically distributed so that the physical properties related to some bulk operation vary over the layer. This spatial variance of properties is chosen so that when a bulk operation (heating to melt powders is the preferred embodiment) is performed, only materials on the parametric surface representing the slice of the current layer are consolidated.

The rest of this description presents examples of several alternative embodiments of the process which are claimed: some which depend on varying physical properties by distributing multiple materials and some which depend on using additives to change physical properties of either the same or different materials.

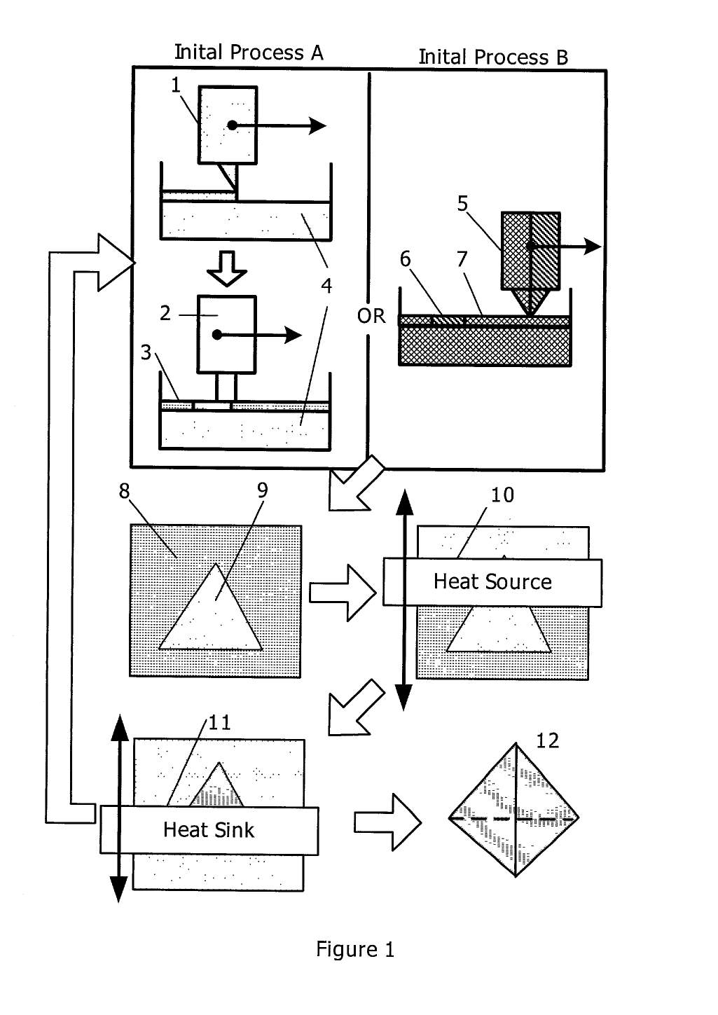

In a single-powder system, based on the geometry of a layer, selected areas are wetted to form different zones as shown in initial process A of FIG. 1. In order to reduce smearing of the liquid to some unwanted area, the powder layer is optionally compacted or preheated. Alternatively, a multiple-powder system is used: layers composed of two classes of materials are uniformly spread out as shown in initial process B of FIG. 1. In both systems, the base powder layer 4 is prepared as a buffer zone between the part to be fabricated and the base surface of the system.

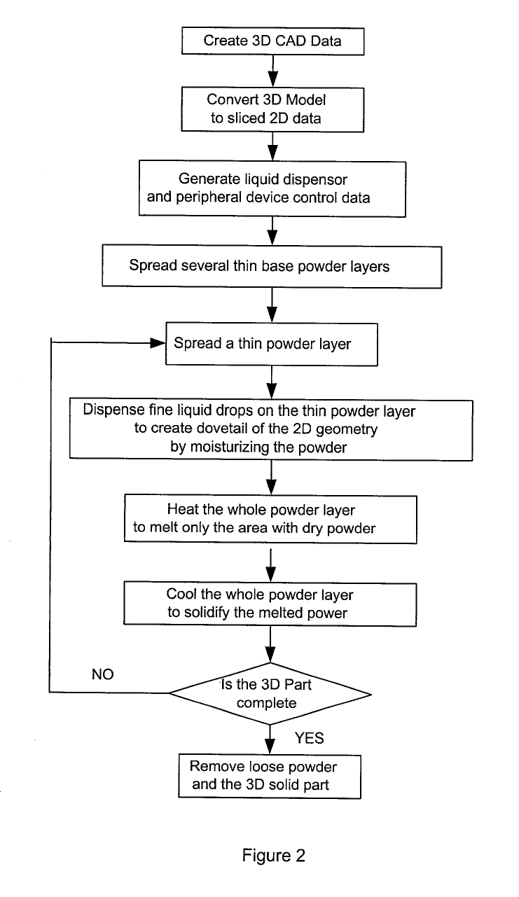

FIG. 2 describes the essential process steps when liquid drops are used to create local variations in physical properties. Here, in order to melt regions of material (powder being the preferred embodiment) where liquid has been added, the liquid must first be vaporized. Since the mixture of powder and liquid remains at a the melting temperature of the liquid until the liquid has been vaporized, regions where liquid has been added can be kept below the melting temperature of the powder by using the appropriate liquid, i.e., one with a low enough melting temperature, high enough heat capacity, and high enough thermal absorptivity. The first stages of the process are the same for this process and the embodiment using multiple powders to create local variations in physical properties. These steps have been described in the first paragraphs of this section.

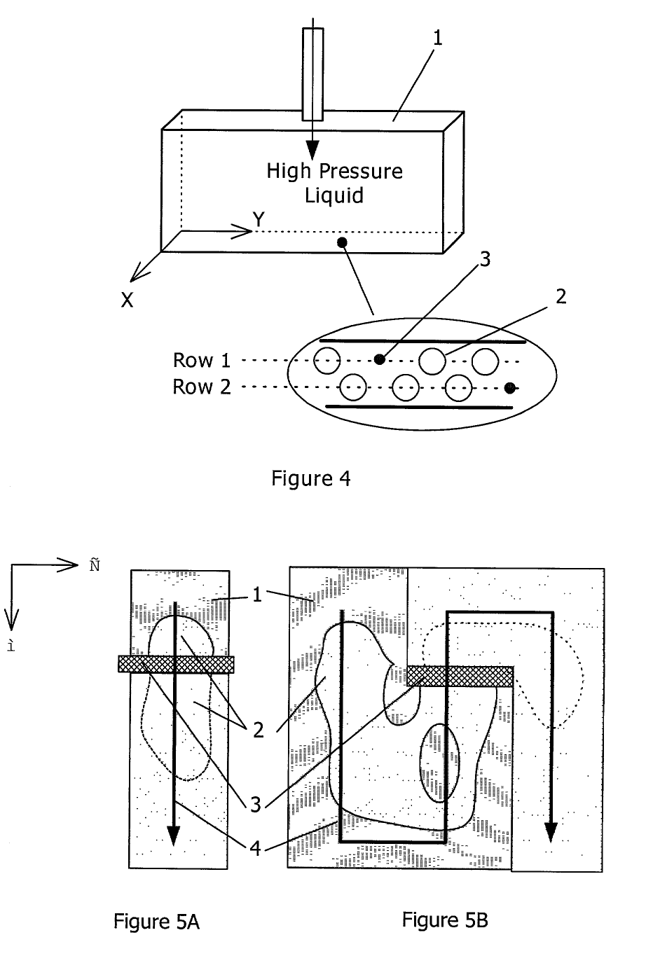

Referring to the part of FIG. 1 that shows an embodiment of a single-powder system: the powder delivery system 1 spreads a thin layer of powder. Computer controlled liquid dispenser 2 wets pre-defined area 8 with fine liquid drops, which is determined by the sliced two-dimensional CAD data. Melting the wetted area 8 requires more energy in comparison to the dry area 9, as melting wetted area should accompany phase change. As a consequence, there exists a range of heat flow rate that only melts dry powder areas. One technique for dispensing the find liquid drops is depicted in FIG. 4. A dispenser 1 contains pressurized liquid with electrically actuated membrane holes 2 and 3. The liquid is dropped through an open hole 2 but not through a closed hole 3. Once the droplets have been dispensed, the dispenser and powder undergo relative motion in the X direction of FIG. 4. Then, if cross-section is larger in the Y direction than the dispenser 1, the dispenser and powder undergo a relative motion in the Y direction as shown in FIG. 5B. Otherwise, the wetting stage of the process is complete, as depicted in FIG. 5A. Inkjet technology, where the droplets are formed by rapid changes in the volume of the dispenser instead of obstructing the membrane holes, may also be used. Power, temperature, surface area, and feed rate of the heat source 10 are the major parameters that determine the heat flow rate. In addition, one can control the gap between the heat source 10 and the powder surface 3 to attain a proper level of heat flow rate to powder. As a means to expedite the solidification of the melted powder, a heat sink 11 can be used as a cold junction. Similar to the heat source, the heat flow rate from powder to heat sink is determined by power, temperature, surface area and feed rate of the heat sink 11. If undesirable thermal deformation is detected, one can skip this active cooling process. Thermal deformation can also be prevented by preheating the powder to a temperature near its melting point. As shown in FIG. 1, the powder spreading, selective wetting, heating and cooling processes are repeated until the final part 12 is completed. After the process cycle, the loose powder is removed from the solidified parts using brush, flowing fluid, agitation in a bed of abrasives (such as a fine sand), or high speed air flow.

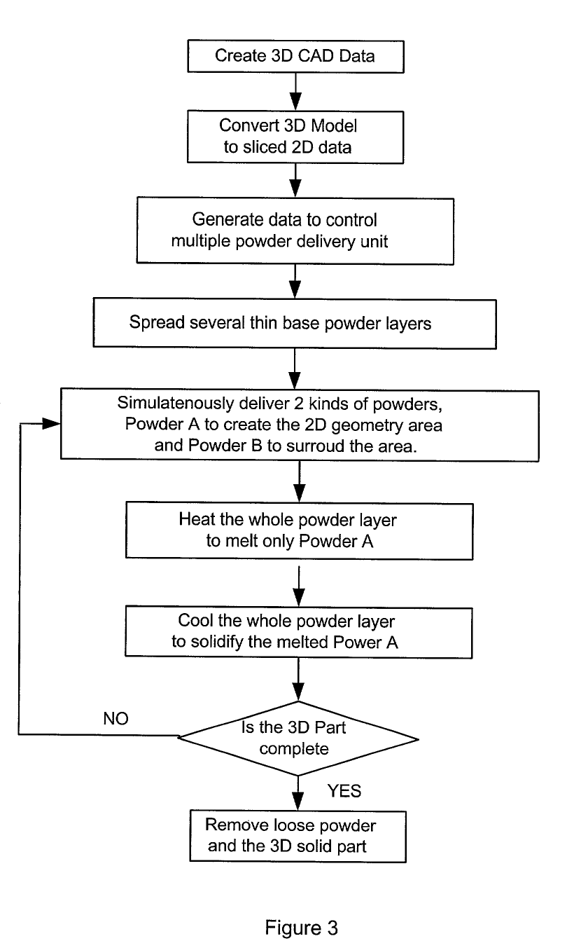

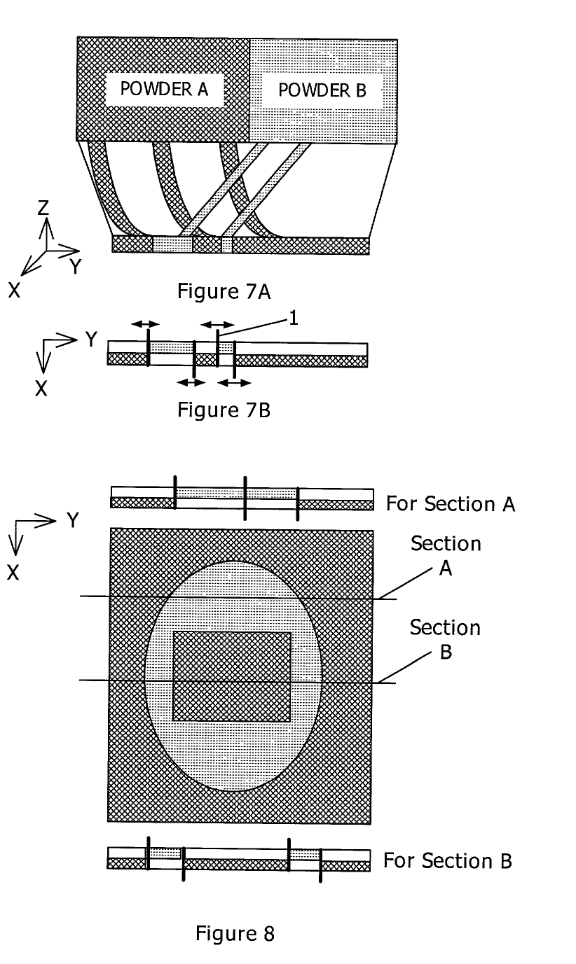

As an alternative to a single-powder process, one can attain areas with different local material properties by delivering two or more powders using a multiple powder delivery system 5. The surrounding powder 7 that requires higher energy to be melted plays the same role as the wetted powder 8 in the single-powder system. The rest of the process is the same as the single-powder system. FIG. 3 shows a flow chart for the multiple-powder process. Two embodiments for selectively delivering powder in a multiple-powder system are discussed below. The front and bottom view of a multiple-powder delivery system based on moving gates are depicted in FIG. 7A and FIG. 7B, respectively. Powder A and Powder B in the separate hoppers are fed into flexible powder chambers separated by electromechanical gates 1. The entire assembly undergoes relative motion in the X direction of FIG. 7 while the gates 1 are moved so that Powder B is deposited in the shape of a cross-section of the part being fabricated and Powder A fills the inverse of this shape. The complexity of the part geometry that can be formed with a single pass of the cartridge over the layer (as in FIG. 5A) is determined by the number of the gates.

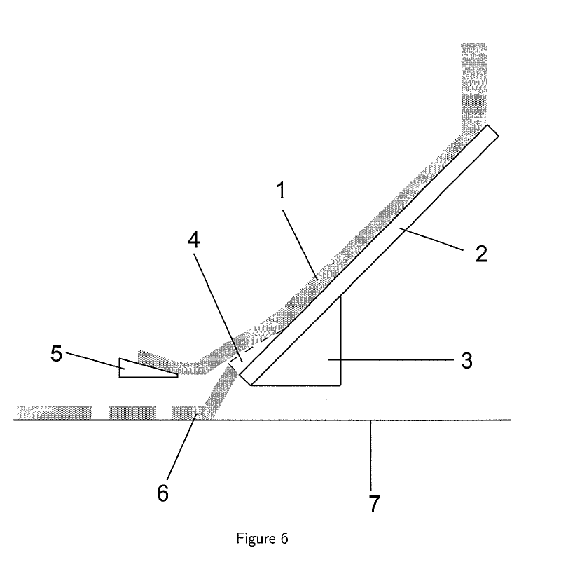

As an example, when feeding the powder cartridge with gates 1 in the X direction of FIG. 7, the gates should be in the configuration labeled For Section A in FIG. 8 at Section A, and the gates should take the configuration labeled For Section B at Section B. Thus, at least four gates are necessary to create the two-dimensional powder surface shown in FIG. 8. In order to fabricate more complex parts, the number of gates should be increased and/or the number of the powder cartridge paths should be increased similar to FIG. 5B. FIG. 6 depicts an embodiment of a multiple-powder system that uses a linear array of piezoelectric actuators. As a first powder 1 is fed onto a membrane 2, which is tensioned and positioned at its base by a pair of blocks 3, the bimorph actuators, which are in an array extending perpendicular to the page, deform selected portions of the membrane into a deflected position 4. Since the deflected position cannot be held in static equilibrium with piezoelectric actuators, an oscillating voltage is applied that deforms the membrane into a deflection that is the mirror image of that shown—portions of the membrane deflected above the neutral axis are below and vice-versa. As the first powder traverses the membrane in regions where these oscillating deflections exist, it is deflected to a catch 5 where it can be recycled. Otherwise, the powder falls down to form a new layer of material 6 which resides on top of a previously deposited layer 7. Gaps where no powder has been deposited are filled with a second powder using the same process as above.

In summary, the present invention exploits two zones with different material properties formed by selectively wetting a layer of material with liquid whose phase changes to gas below powder melting point and/or depositing different powders, in order to effectively fabricate geometrically complex objects layer by layer. In case of differentiating zones by selectively wetting a powder layer, only unwetted powder is solidified due to the additional energy required for the phase change of liquid to gas. In case of differentiating zones by depositing different powders, the powder with relatively high melting temperature is remained loose whereas the other powder is melted and cooled to form a cross section of a solid object with sufficient mechanical strength. The whole process can be performed in open air or in a closed chamber. Usually, a closed chamber filled with an inert gas is used to prevent unwanted chemical reactions as the powder is heated; because the surface area of the powder is large relative to its volume, powders are more susceptible to rapid oxidation than the final consolidated part. As mentioned above, the powders are usually heated before being distributed into layers to avoid residual thermal stresses or strain during solidification. This preheating often necessitates the use of an inert gas since it increases the rate of oxidation.

Once the selected areas of the powder layer are melted, heat flux is actively controlled to produce parts with small geometric distortion and residual stresses. In contrast to free cooling, temperature gradients of the powder layer during solidification is reduced. Besides, unwanted melting of the subsequent powder layer to the previous layer can be prevented.

1. A method for producing parts comprising:
(a) depositing a layer of material(s) and, optionally, additive(s) on a predefined surface, wherein selected areas of said layer are differentiated from the rest area of said first layer by contrasting local material properties;
(b) consolidating said selected areas by applying a bulk operation to the entire layer;
(c) optionally, controlling the rate of the aforementioned bulk operation to affect residual stresses in the consolidated areas;
(d) repeating steps 1a through 1c by depositing additional layers of material(s) and optionally additive(s) on top of existing layers until the entire part is formed from the union of all consolidated regions of all layers.

2. The method of claim 1, wherein said local material properties are thermal properties, including but not limited to heat capacity, thermal conductivity, and enthalpy, and the aforementioned bulk operation is the bulk heating of the layer using any combination of radiative, convective, or conductive heat transfer.

3. The method of claim 2, wherein active heat transfer is used during a stage of the process to minimize thermal distortions, where the stage is any of: the preheating, melting, or solidifying of the aforementioned selected areas of the layer thermal distortions.

4. The method of claim 2, wherein the aforementioned contrasting local material properties are accomplished in part or whole with an additive whose phase change prevents consolidation or decomposition of the selected material(s) during the aforementioned bulk heating operation.

5. The method of claim 4, where the aforementioned additive is a liquid applied in fine drops on said selected areas.

6. The method of claim 5, wherein said material(s) are compacted before the step of moisturizing, in order to reduce smearing of liquid to the rest of said area, if necessary.

7. The method of claim 5, wherein said material(s) are also preheated before the step of moisturizing, in order to reduce smearing of liquid the to rest of said area, if necessary.

8. The method of claim 5, wherein properties of said liquid drops are chosen considering those of the material(s) forming the layer and properties are any of the following: temperature, heat capacity, thermal conductivity, enthalpy, viscosity, boiling temperature and wetting angle.

9. The method of claim 5, wherein said the step of dispensing fine liquid drops is done by employing inkjet printer type cartridge.

10. The method of claim 5, wherein said the step of applying fine liquid drops is accomplished by covering selected areas of some region of the layer and spraying liquid mist over the entire aforementioned region.

11. The method of claim 2, where additives are also used to selectively color regions to be consolidated and thus fabricate parts with arbitrary colorings.

12. The method of claims 5 and 11, wherein dispensing said colored liquid drops is performed using color inkjet technology.

13. The method of claim 1, wherein said contrasting local material properties is also accomplished by delivering two classes of materials with different properties.

14. The method of claims 2 and 13, such that one class of materials will melt below the temperature to which the aforementioned layer is heated and the other class of materials will not, thus selecting areas of the layer to be consolidated.

15. The method of claims 1 and 13, where each class of material(s) is deposited onto the aforementioned surface using the following process:
(a) material(s) are deposited onto a flexible actuator surface while said surface is forced into a mode of vibration,
(b) the vibrations of the actuator surface cause the material(s) to move perpendicular to the actuator surface,
(c) this motion is used to select the amount of said material to be deposited on the surface of claim 1, and
(d) steps 15a through 15c are repeated for each class of material(s).

16. The method of claim 15 where the actuators are an array formed along a single curve and said curve is held a small distance above the layer surface of claim 1 while being translated parallel to this surface.

17. The method of claim 16 where some force pulls said material(s) across the actuator surface and the source of the force is one or more of: gravity, fluid convection, an electric field, a magnetic field, mechanical vibration parallel to the actuator surface.

18. The method of claim 15 where the motion of said material(s) away from the actuator surface routes only material(s) that travel some given distance from the actuator surface away from the layer surface of claim 1 while all other material(s) are deposited onto the layer surface of claim 1.

19. The method of claims 16, 17, and 18, wherein the aforementioned flexible actuator surface is a piezoelectric membrane with an array of electrodes placed along a line at one edge of the surface and whose electrodes are independently driven with oscillating voltages to produce the desired vibrations that move the material(s) away from the membrane such that only the material(s) with small motions away from said membrane are transferred to the surface of claim 1 by the force of claim 17 while the remaining material(s) are routed away from the layer being deposited.

20. The method of claim 13, wherein said two classes of materials are also delivered using a cartridge that contains multiple materials in separate but adjacent chambers each of which deposits powder beneath the chamber as it is moved from a slot of adjustable width perpendicular to the direction of motion.

21. The method of claims 1, 13, and 20, wherein said classes of material(s) are deposited so as to completely cover the aforementioned surface by moving said material cartridge over said surface one or more times while adjusting the width of each slot so as to select which areas of the layer are formed by a specific class of material(s).

22. The method of claim 20, wherein the surface , on which powders are spread out, is slightly tilted to the opposite direction of powder cartridge feeding.
